(19) United States
(12) Patent Application Publication
(10) Pub. No.: US 2020/0195317 A1
(43) Pub. Date: Jun. 18, 2020

(54) USER APPARATUS AND COMMUNICATION METHOD

(71) Applicant: NTT DOCOMO, INC., Tokyo (JP)

(72) Inventors: Shinpei Yasukawa, Tokyo (JP); Satoshi Nagata, Tokyo (JP); Qun Zhao, Beijing (CN); Xiaolin Hou, Beijing (CN); Xufei Zheng, Beijing (CN); Huan Wang, Beijing (CN)

(73) Assignee: NTT DOCOMO, INC., Tokyo (JP)

(21) Appl. No.: 16/609,679

(22) PCT Filed: May 2, 2017
(86) PCT No.: PCT/JP2017/017312

§ 371 Date: Oct. 30, 2019

(51) Int. Cl. H04B 7/0456; H04L 5/00; H04W 72/04

(52) U.S. Cl. CPC H04B 7/0456; H04W 92/18; H04W 72/0406; H04L 5/0048

(57) ABSTRACT

Disclosed is a user apparatus for use in a radio communication system that supports a D2D communication. The user apparatus includes a setting information storage unit configured to store a plurality of precoding matrices; and a signal transmission unit configured to precode a D2D signal and transmit the precoded D2D signal while switching a precoding matrix among the plurality of precoding matrices in a time domain, in a predetermined time interval including a plurality of unit time intervals. The signal transmission unit maps a reference signal precoded by a same precoding matrix to at least two unit time intervals in the predetermined time interval.

### TECHNICAL FIELD

The present invention relates to a user apparatus in a radio communication system.

### BACKGROUND ART

In LTE (Long Term Evolution) and the successor systems of LTE (e.g., LTE-A (LTE Advanced), NR (New Radio) (also called 5G)), D2D (Device to Device) technology in which user apparatuses directly communicate with each other without going through a radio base station has been studied.

D2D reduces the traffic between user apparatuses and a base station and enables communications between the user apparatuses even when the base station becomes unable to communicate in the event of a disaster, etc.

D2D technology is roughly divided into D2D discovery and D2D communication; D2D discovery being used for finding other communicative user apparatuses and D2D communication being used for direct communication between user apparatuses (also referred to as D2D direct communication, D2D communication, terminal-terminal direct communication, etc.). In the following, the above-described D2D communication, D2D discovery, etc. may be simply called D2D when they are not specifically distinguished. Further, a signal transmitted and received by D2D is referred to as a D2D signal.

In 3GPP (3rd Generation Partnership Project), D2D is referred to as “side link (sidelink)”; however, a more general term “D2D” is used in this specification. However, sidelink is also used as necessary in the description of the embodiment to be described later.

In 3GPP, implementation of V2X (Vehicle Attachment Everything) has been studied by extending the D2D function, and specifications of V2X are in progress. Note that V2X is a part of ITS (Intelligent Transport Systems); V2X is, as illustrated in FIG. 1, a generic term for a V2V (Vehicle to Vehicle) indicating a communication mode between vehicles, a V2I (Vehicle to Infrastructure) indicating a communication mode between a vehicle and a RSU (Road-Side Unit) installed by the roadside, a V2N (Vehicle to Nomadic device) indicating a communication mode between a vehicle and a mobile terminal of a driver, and a V2P (Vehicle to Pedestrian) indicating a communication mode between a vehicle and the mobile terminal of a pedestrian.

In Rel-14 of LTE, specifications of several functions of V2X have been made (e.g., Non-Patent Document 1). In these specifications, Mode 3 and Mode 4 are defined with respect to resource allocation for V2X communication to a user apparatus. In Mode 3, transmission resources are allocated dynamically by DCI (Downlink Control Information) sent from a base station to a user apparatus. In Mode 3, SPS (Semi Persistent Scheduling) is also possible. In Mode 4, a user apparatus autonomously selects transmission resources from the resource pool.

### RELATED ART DOCUMENTS

### Non-Patent Documents

[NON-PATENT DOCUMENT 1] 3GPP TS 36.213 V14.2.0 (2017 March)
[NON-PATENT DOCUMENT 2] 3GPP TS 36.211 V14.2.0 (2017 March)

### SUMMARY OF THE INVENTION

### Problem to be Solved by the Invention

In V2X (especially V2V), which is expected to perform D2D communication between terminals moving at high speeds, studies have been conducted to improve the quality and reliability of communications by applying transmit diversity to the user apparatus for transmission. As one of transmit diversity technologies, precoding vector switching (PVS) may be given; PVS switches precoding vectors in the time domain. Studies have been conducted on the application of this PVS to D2D such as V2X. However, a specific technology for applying PVS to perform D2D communication has been yet to be proposed.

The present invention has been made in view of the above-described points, and it is an object of the present invention to provide a technology for allowing a user apparatus to apply a precoding vector switch to appropriately perform D2D communication in a radio communication system that supports D2D communication.

### Means for Solving the Problem

According to a disclosed technology, a user apparatus in a radio communication system that supports a D2D communication is provided. The user apparatus includes

a setting information storage unit configured to store a plurality of precoding matrices; and

a signal transmission unit configured to precode a D2D signal and transmit the precoded D2D signal while switching a precoding matrix among the plurality of precoding matrices in a time domain, in a predetermined time interval including a plurality of unit time intervals, wherein

the signal transmission unit maps a reference signal precoded by a same precoding matrix to at least two unit time intervals in the predetermined time interval.

### Advantageous Effect of the Present Invention

According to the disclosed technology, a user apparatus is enabled to apply a precoding vector switch to appropriately perform D2D communication, in a radio communication system supporting D2D communication.

### BRIEF DESCRIPTION OF THE DRAWINGS

FIG. 1 is a diagram illustrating V2X;

FIG. 2A is a diagram illustrating D2D;

FIG. 2B is a diagram illustrating D2D;

FIG. 3 is a diagram illustrating MAC PDU for use in D2D;

FIG. 4 is a diagram illustrating a format of SL-SCH subheader;

FIG. 5 is a diagram illustrating a configuration example of a radio communication system according to an embodiment;

FIG. 6 is a diagram illustrating a functional configuration relating to signal transmission in a first embodiment;

FIG. 7 is a diagram illustrating an example of a codebook in a first embodiment (and second to fourth embodiments);

FIG. 8A is a diagram illustrating an operation example of a user apparatus UE in the first embodiment;

FIG. 8B is a diagram illustrating an operation example of a user apparatus UE in the first embodiment;

FIG. 8C is a diagram illustrating an operation example of a user apparatus UE in the first embodiment;

FIG. 9 is a diagram illustrating a functional configuration relating to signal transmission in a second embodiment;

FIG. 10 is a diagram illustrating an operation example of a user apparatus UE in the second embodiment;

FIG. 11 is a diagram illustrating a functional configuration relating to signal transmission in a third embodiment;

FIG. 12 is a diagram illustrating an operation example of a user apparatus UE in the third embodiment;

FIG. 13A is a diagram illustrating an operation example of a user apparatus UE in a fourth embodiment;

FIG. 13B is a diagram illustrating an operation example of a user apparatus UE in the fourth embodiment;

FIG. 14A is a diagram illustrating an operation example of a user apparatus UE in the fourth embodiment;

FIG. 14B is a diagram illustrating an operation example of a user apparatus UE in the fourth embodiment;

FIG. 15 is a diagram illustrating a functional configuration example of a user apparatus UE according to an embodiment;

FIG. 16 is a diagram illustrating a functional configuration example of a base station 10 according to an embodiment; and

FIG. 17 is a diagram illustrating a hardware configuration example of a user apparatus UE and a base station 10 according to an embodiment.

### EMBODIMENTS FOR CARRYING OUT THE INVENTION

The following describes embodiments according to embodiments of the present invention with reference to the accompanying drawings. Note that the embodiments described below are merely examples and the embodiments to which the present invention is applied are not limited to the following embodiments. For example, it is assumed that a radio communication system according to an embodiment complies with LTE standards. However, the present invention may be applied not limited to LTE but may also be applied to other systems. Note that, in the specification and the claims, the term “LTE” is used not only to mean a communication scheme corresponding to 3GPP release 8 or 9, but also to mean the fifth-generation (5G, NR) mobile communication system corresponding to 3GPP release 10, 11, 12, 13, 14 or beyond.

Further, although a technology according to the present embodiment may be applied mainly to V2X, the application of the technology according to the present embodiment is not limited to V2X, but may be widely applicable to D2D in general. The aspect of the “D2D” includes V2X in this sense. In addition, the term “D2D” is not limited to LTE, but refers to general communications between terminals. Further, although the present embodiment is mainly applicable to “D2D communications”, the present invention is applicable not only to “D2D communications” but is also applicable to “D2D discovery”.

Furthermore, unless otherwise specified, the “D2D signal” may be a data signal, an SCI, a discovery signal, or a combination of the SCI and the data signal.

### Overview of D2D

The present embodiment employs D2D as a basic technology; hence, an outline of D2D prescribed in LTE will be described first. It should be noted that V2X may also employ the D2D technology described below, and a user apparatus in this embodiment is enabled to transmit and receive D2D signals according to the technology.

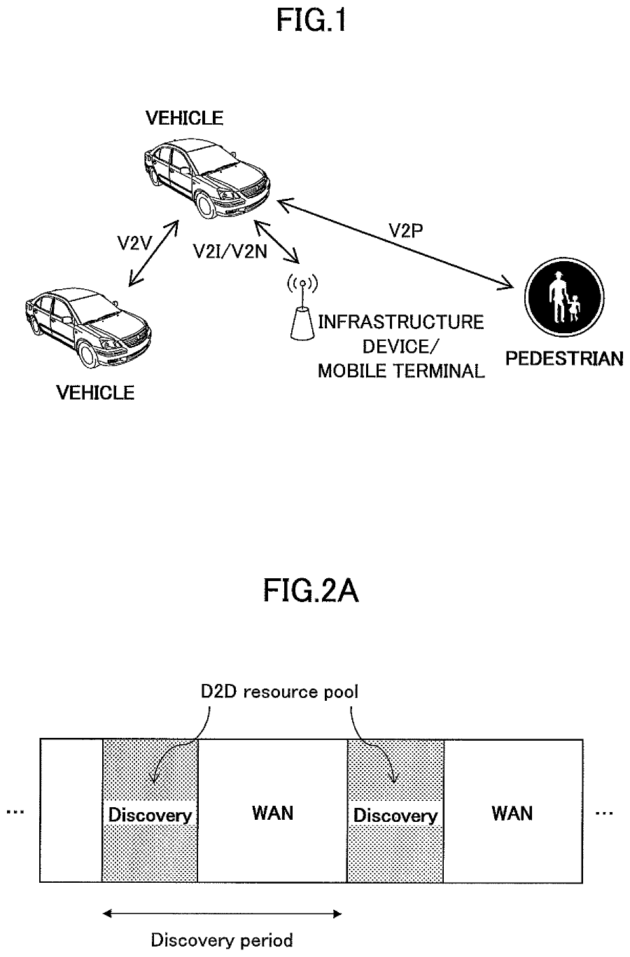

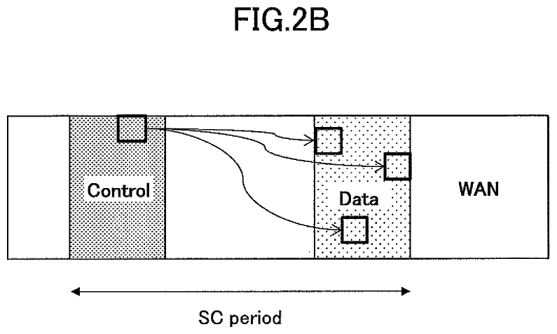

As already described above, D2D is roughly divided into “D2D discovery” and “D2D communications”. With respect to “D2D discovery”, as illustrated in FIG. 2A, a resource pool for a Discovery message is acquired for each Discovery Period, and a user apparatus transmits a Discovery message (discovery signal) within the resource pool. More specifically, there are Type 1 and Type 2b in the “D2D discovery”. In Type 1, the user apparatus autonomously selects transmission resources from the resource pool. In Type 2b, semi-static resources are allocated by higher layer signaling (e.g., RRC signal).

Likewise, with respect to “D2D communications”, resource pools for SCI (Sidelink Control Information)/data transmission are periodically secured as illustrated in FIG. 2B. The transmitting end user apparatus reports data transmission resources (PSSCH resource pool) etc. to a receiving end user apparatus via the SCI with the selected resources selected from a control resource pool (PSCCH resource pool), and transmits the data with the data transmission resources. Specifically, there are Mode 1 and Mode 2 in the “D2D Communications”. In Mode 1, resources are dynamically allocated by an (E) PDCCH transmitted from a base station to a user apparatus. In Mode 2, a user apparatus autonomously selects transmission resources from a resource pool. The resource pool used may be reported via SIB or by using a predefined resource pool.

Further, as described above, in Rel-14, there are Mode 3 and Mode 4 in addition to Mode 1 and Mode 2. In Rel-14, SCI and data may be transmitted simultaneously (in one subframe) with resource blocks adjacent in a frequency direction. It should be noted that the SCI may be referred to as SA (Scheduling Assignment).

In LTE, the channel for use in “D2D discovery” is referred to as PSDCH (Physical Sidelink Discovery Channel). The channel for transmitting control information such as SCI in “D2D Communications” is referred to as PSCCH (Physical Sidelink Control Channel). The channel for transmitting data is referred to as PSSCH (Physical Sidelink Shared Channel) Further, PSCCH and PSSCH have a PUSCH based structure, into which DMRS (Demodulation Reference Signal, demodulation reference signal) is inserted.

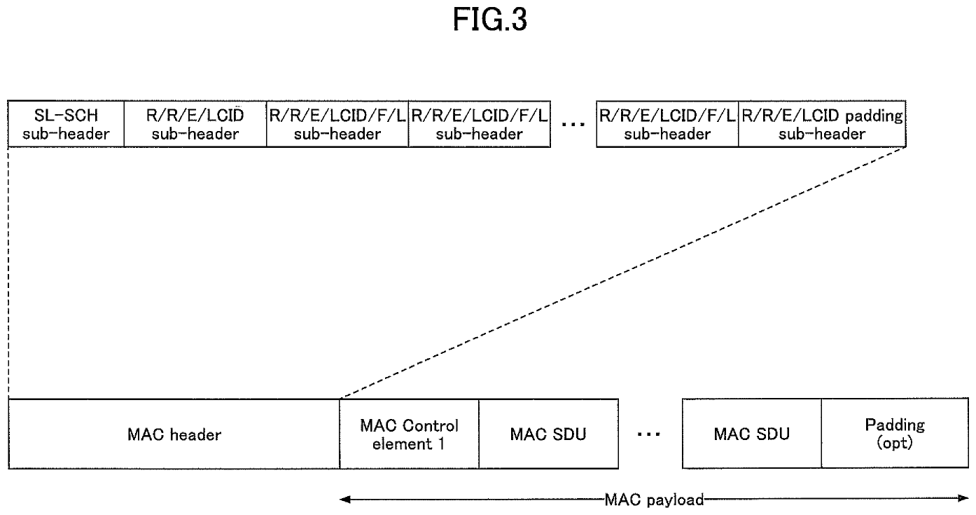

As illustrated in FIG. 3, the MAC PDU for use in the D2D communication includes at least MAC header, MAC Control element, MAC SDU (Service Data Unit), and Padding. As illustrated in FIG. 3, MAC (Medium Access Control) PDU (Protocol Data Unit) includes at least MAC header, MAC Control element, MACSDU (Service Data Unit), and Padding. MAC PDU may contain other information. The MAC header includes one SL-SCH (Sidelink Shared Channel) subheader and one or more MAC PDU subheaders.

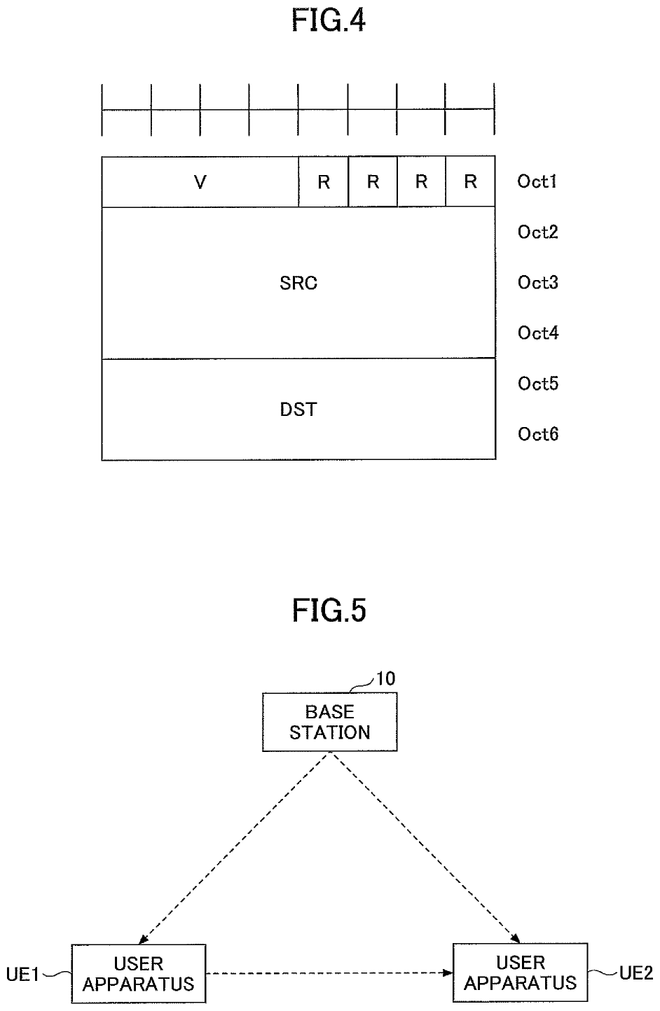

As illustrated in FIG. 4, the SL-SCH subheader includes a MAC PDU format version (V), transmission source information (SRC), transmission destination information (DST), Reserved bit (R) and the like. V is assigned to the head of the SL-SCH subheader and indicates a MAC PDU format version used by a user apparatus. Information associated with a transmission source is set in transmission source information. An identifier associated with ProSe UE ID may be set in the transmission source information. Information associated with a transmission destination is set in transmission destination information. Information associated with ProSe Layer-2 Group ID of a transmission destination may be set in the transmission destination information.

### System Configuration

FIG. 5 is a diagram illustrating a configuration example of a radio communication system according to an embodiment. As illustrated in FIG. 5, a radio communication system according to an embodiment includes a base station 10 and user apparatuses UE1 and UE2. In FIG. 5, the user apparatus UE1 is intended for a sender side, the user apparatus UE2 is intended for a receiver side; however, each of the user apparatus UE1 and the user apparatus UE2 has both a sending function and a receiving function. Hereinafter, the user apparatus UE1 and the user apparatus UE2 may be simply referred to as “user apparatus UE” when not particularly distinguishing between the user apparatus UE1 and the user apparatus UE2.

A user apparatus UE1 and a user apparatus UE2 depicted in FIG. 5 each have a function of cellular communication for a user apparatus UE in LTE (LTE including 5G and NR in addition to existing LTE, hereinafter the same) and have a D2D function including signal transmission and reception on the above-described channels. The user apparatus UE1 and the user apparatus UE2 each further have a function of performing operations described in the embodiments.

Further, the user apparatus UE may be any apparatus having a function of D2D; for example, the user apparatus UE may be a vehicle, a terminal held by a pedestrian, an RSU (a UE type RSU having a UE function), or the like.

The signal waveform used by the user apparatus UE may be a CP-OFDM (a waveform used in downlink of the existing LTE), a DFT-S-OFDM (DFT-Spreading-OFDM)), or any other signal waveforms.

In addition, a processing content of D2D transmission in the user apparatus UE is basically the same as a processing content of the uplink transmission in the LTE (Non-Patent Document 2). For example, the user apparatus UE scrambles and modulates codewords of transmission data, generates complex-valued symbols, and maps the complex-valued symbols (transmission signals) to one or two layers, thereby performing precoding. The user apparatus UE then maps the precoded complex-valued symbols to resource elements to generate a transmission signal (e.g., complex-valued time-domain SC-FDMA signal) and transmit the generated transmission signal via each antenna port. In the following embodiments, a description mainly focuses on precoding and reference signal mapping as a description of transmission processing.

Note that precoding a signal with a precoding vector indicates multiplying a signal by a precoding vector, according to which a transmission beam may be formed. Switching a precoding vector according to a lapse of time as in PVS (Precoding Vector Switching) in a time domain corresponds to switching a transmission beam direction according to a lapse of time. PVS in this embodiment is PVS in the time domain. Further, an antenna port is a logical antenna port corresponding to one or a plurality of antenna elements. Further, “precoding vector” may be referred to as “precoding matrix”. “Precoding vector” is a type of “precoding matrix”.

The base station 10 has a function of cellular communication for a base station 10 in LTE and a function (setting of DMRS mapping pattern etc.) for enabling communication of the user apparatus UE in this embodiment. Further, the base station 10 may be an RSU (eNB type RSU having the function of eNB).

The user apparatus UE in the present embodiment applies a PVS and transmits a data signal (PSSCH). The following illustrates first to fourth embodiments as specific examples thereof. In the first to fourth embodiments, the technology applied to the data signal may be applied to a control signal or a discovery signal.

### First Embodiment

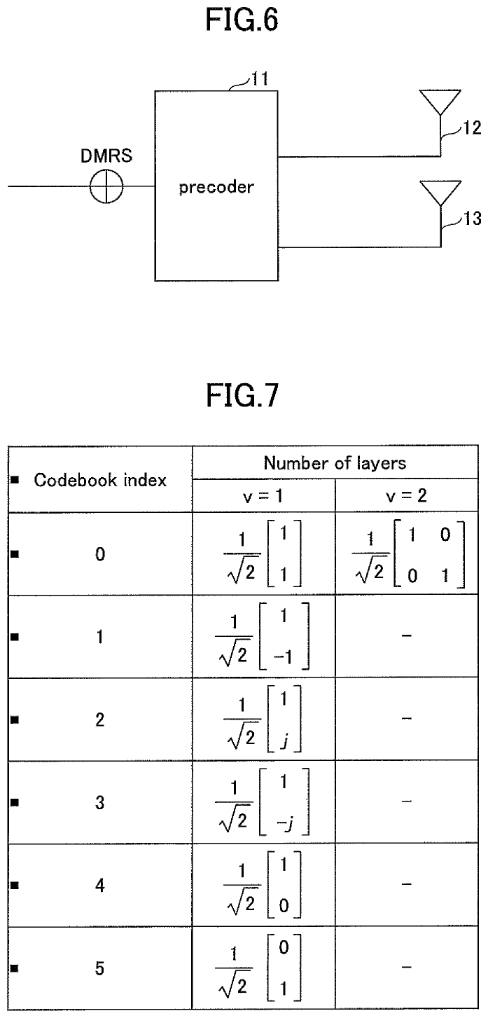

FIG. 6 is a diagram illustrating functional units (functional units included in a signal transmission unit 101 described later) related to precoding and signal transmission of the user apparatus UE1 in a first embodiment. As illustrated in FIG. 6, the functional units include a precoder 11 configured to precode a transmission signal (multiplying by precoding vector) and antenna ports 12 and 13. In the first embodiment (similarly in second to fourth embodiments), it is assumed that each antenna port corresponds to one antenna element (physical antenna element); however, each antenna port may correspond to a plurality of antenna elements.

The precoder 11 receives data signals and DMRSs input as transmission signals, and precodes these signals to transmit the precoded signals from each antenna port as radio signals. As an example, DMRS is a Zadoff-Chu sequence similar to LTE, and is capable of generating multiple orthogonal DMRS by cyclic shift. This also applies to later-described unprecoded RSs.

The precoder 11 in the first embodiment holds a plurality of precoding vectors in a memory or the like, and switches each precoding vector according to time. The plurality of precoding vectors are not particularly specified; however, the precoding vectors described in the codebook used for antenna ports {20, 21} are used in the first embodiment. This codebook is disclosed in Non-Patent Document 2.

FIG. 7 depicts such a codebook. More specifically, the user apparatus UE1 uses precoding vectors of indices 0, 1, 2, and 3. In the following description (including second to fourth embodiments), the precoder 11 in the time to use precoding vector of index 0 may be referred to as precoder 0, the precoder 11 in the time to use precoding vector of index 1 may be referred to as precoder 1, the precoder 11 in the time to use precoding vector of index 2 may be referred to as the precoder 2, and the precoder 11 in the time to use precoding vector of index 3 may be referred to as precoder 3. Switching precoding vectors according to time may be referred to as precoder cycling.

In the first embodiment, a different orthogonal DMRS sequence is used for each precoder (precoding vector) in the precoders 0 to 3. Each of the plurality of different DMRSs may be associated with a corresponding one of DMRS ports (antenna port for DMRS). For example, DMRS input to precoder 0 is associated with a DMRS port 0, DMRS input to the precoder 1 is associated with a DMRS port 1, DMRS input to the precoder 2 is associated with a DMRS port 2, and DMRS input to the precoder 3 is associated with a DMRS port 3. Multiple DMRSs of different DMRS ports are mapped (multiplexed) to resource elements. It is also possible to multiplex a plurality of different DMRSs without using such a concept of “port”. In addition, CDM or FDM may be used for multiplexing of different DMRSs.

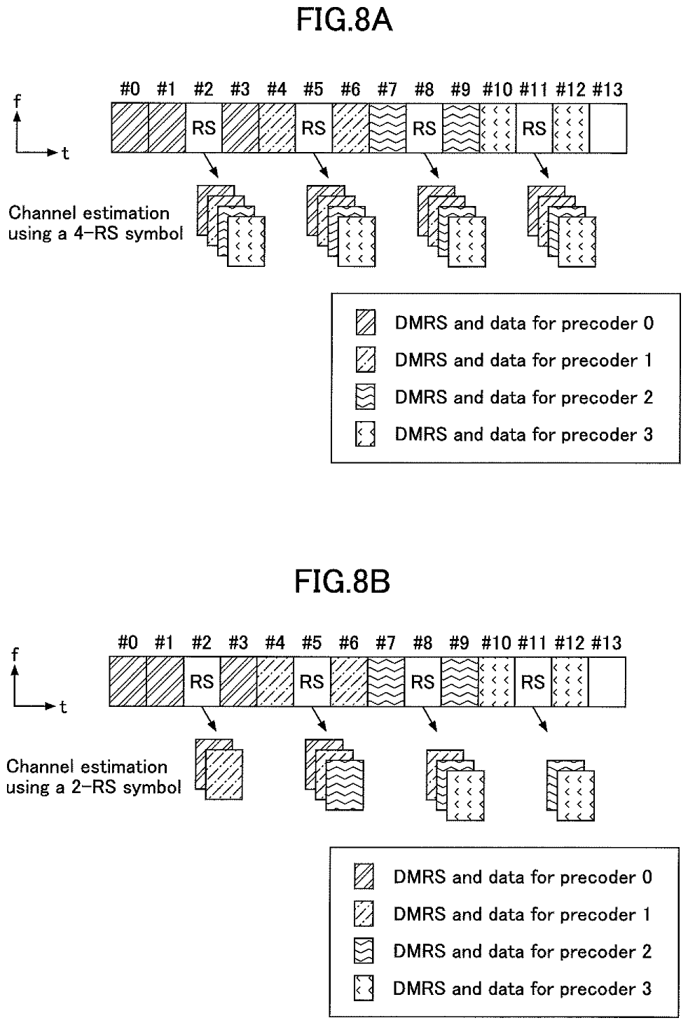

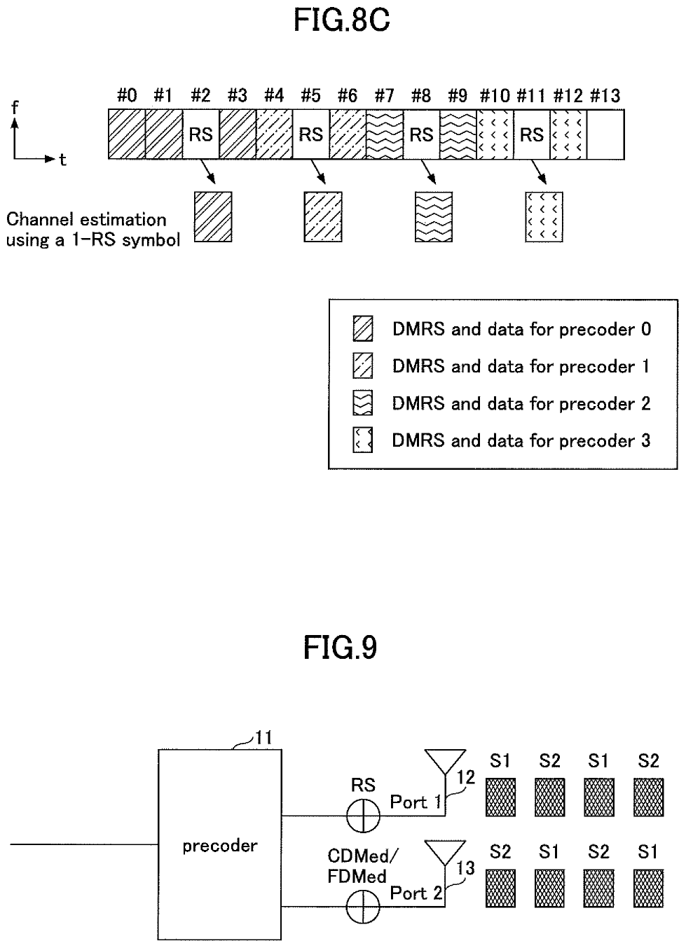

With reference to FIGS. 8A to 8C, examples of mapping data signals and DMRSs to resources (more specifically, resource elements) are described. In FIGS. 8A to 8C, the length in the lateral direction of an oblong rectangle where the mapping is illustrated is one subframe (this may be referred to as a slot or a TTI), and the length in the vertical direction is one subcarrier. Note that the length in the vertical direction may be a plurality of subcarriers. This also applies to the mapping diagrams in the second to fourth embodiments.

As illustrated in each example of FIGS. 8A to 8C, one subframe includes 14 symbols, and the data signal and the DMRS are mapped. Note that symbol #13 is a Gap (puncture) symbol. The same also applies to the second to fourth embodiments with respect to one subframe including 14 symbols and symbol #13 being a Gap. Note that one subframe is an example of “predetermined time interval”, and one symbol is an example of “unit time interval”. In the first to fourth embodiments, one subframe is used as the “predetermined time interval” and one symbol is used as the “unit time interval”; however, these are examples. For example, in the first to fourth embodiments, a time interval longer (or shorter) than one subframe may be used as the “predetermined time interval”, and a time interval longer (or shorter) than one symbol may be used as the “unit time interval”.

Further, a time position at which a precoder is switched is referred to as a switch time position, and an interval between two switch time positions (not including either switch time position) is referred to as a switch time interval.

In any of the examples of FIGS. 8A to 8C, the user apparatus UE1 maps data signals precoded by the precoder 0 to the symbols #0, #1, and #3, maps data signals precoded by the precoder 1 to the symbols #4 and #6, maps data signals precoded by the precoder 2 to the symbols #7 and #9, and maps data signals precoded by the precoder 3 to the symbols #10 and #12.

DMRS mapping method is different between the examples of FIGS. 8A to 8C. In the example of FIG. 8A, the user apparatus UE1 maps (multiplexes) four different DMRS sequences precoded by the respective precoders of the precoders 0 to 3 to each of the symbols #2, #5, #8, and #11.

The user apparatus UE2 that receives the mapped signal illustrated in FIG. 8A (hereinafter, a user apparatus that receives a mapped signal is defined as the user apparatus UE2) performs channel estimation using the DMRS to which the precoder 0 is applied, and demodulates, based on the channel estimation result, the data signal received at symbols #0, #1, and #3 and precoded by precoder 0. The user apparatus UE2 performs channel estimation using the DMRS to which the precoder 1 is applied and demodulates, based on the channel estimation result, the data signal received at symbols #4 and #6 and precoded by precoder 1. The user apparatus UE2 performs processing on other signals in the similar manner as described above.

In the example of FIG. 8A, four DMRSs precoded by respective precoders are mapped in each of the four symbols to which the DMRSs are mapped, per subframe. Thus, accurate channel estimation may be performed. For example, when considering the DMRS precoded by precoder 0, this DMRS is mapped to four symbols #2, #5, #8, and #11. Thus, the phase rotation of the transmission signal of the transmitting terminal moving at a high speed may be accurately estimated by using the DMRS of each symbol having different time positions, for example. Accordingly, a more accurate channel may be estimated compared to a case of estimating a channel by using one DMRS (or fewer than four DMRSs).

FIGS. 8B to 8C will be described, focusing on differences from FIG. 8A. In the example of FIG. 8B, the user apparatus UE1 maps the DMRSs of two different sequences precoded by the precoders 0 and 1 to the symbol #2, maps the DMRSs of three different sequences precoded by precoders 0 to 2 to the symbol #5, maps the DMRSs of three different sequences precoded by precoders 1 to 3 to the symbol #8, and maps the DMRSs of two different sequences precoded by the precoders 2 and 3 to the symbol #11.

The user apparatus UE2 that receives the mapped signal illustrated in FIG. 8B performs channel estimation using the DMRS to which the precoder 0 is applied and demodulates, based on the channel estimation result, the data signal precoded by precoder 0 and received at symbols #0, #1, and #3. The user apparatus UE2 performs processing on other signals in the similar manner as described above. In the example of FIG. 8B, channel estimation may also be performed using DMRSs with different time positions. In the example of FIG. 8B, as compared with the example of FIG. 8A, the number of DMRSs to be multiplexed into one symbol is small; the transmission power per DMRS of the example in FIG. 8B may thus be made greater than that of the example of FIG. 8A.

In the example of FIG. 8C, the user apparatus UE1 maps one DMRS precoded by the precoder 0 to the symbol #2, maps one DMRS precoded by the precoder 1 to the symbol #5, maps one DMRS precoded by the precoder 2 to the symbol #8, and maps one DMRS precoded by the precoder 3 to the symbol #11.

The user apparatus UE2 that receives the mapped signal illustrated in FIG. 8C performs channel estimation using the DMRS to which the precoder 0 is applied and demodulates, based on the channel estimation result, the data signal precoded by precoder 0 and received at symbols #0, #1, and #3. The user apparatus UE2 performs processing on other signals in the similar manner as described above. In the example of FIG. 8C, channel estimation is unable to be performed using DMRS with different time positions; the channel estimation accuracy in the example of FIG. 8C thus lowers as compared with that of FIGS. 8A and 8B. However, there is an advantage in the example of FIG. 8C that the transmission power per DMRS may be made greater than the examples of FIGS. 8A and 8B.

### Information on Precoder, DMRS Etc.

The receiver end user apparatus UE2 is enabled to identify the switch time position in one subframe and the precoders used in each switch time interval, in accordance with the setting from the base station 10, definitions of the specification, or the like. Further, the user apparatus UE2 is enabled to identify the symbol position to which the DMRS is mapped, each DMRS sequence, precoders applied to each sequence, and which DMRS is mapped to each symbol, in accordance with the setting from the base station 10, definitions of the specification, or the like. Accordingly, the above-described reception operation may be accurately performed.

The user apparatus UE2 does not need to identify all the above information. For example, there may be a case where the user apparatus UE2 is enabled to identify the DMRS being mapped to the symbols #2, #5, #8, and #11, but is not enabled to identify the DMRS sequence (and the corresponding precoder). In such a case, the content of the SCI (SA) or its CRC and the corresponding sequence of the DMRS are associated in advance. Further, a cyclic shift offset (CS offset) for generating the other three sequences from this sequence is also determined in advance. It is assumed that these pieces of information are known by each user apparatus.

The transmitter end user apparatus UE1 then transmits the SCI (control information) with respect to the data signal to be transmitted, maps the sequence of DMRS (precoded by the precoder 0) corresponding to the content of the SCI or the CRC to the symbol #2 (corresponding to the first DMRS, the first precoder 0), maps the three DMRSs generated by using the CS offset to the symbols #5, #8, and #11 and transmits them together with the data signal (e.g., FIG. 8C).

The receiver end user apparatus UE2 receives the SCI and identifies the DMRS sequence mapped to the symbol #2 based on the CRC of the SCI. Further, based on the identified sequence, the user apparatus UE2 identifies the other three DMRSs, performs channel estimation using respective DMRSs, and demodulates the data signals by using CS offset. It is assumed that the user apparatus UE 2 identifies that the DMRSs mapped to the symbols #2, #5, #8, and #11 are precoded by the precoders 0, 1, 2, and 3 based on the switch time positions of the precoders, for example.

According to the above method (method using content of SCI and its CRS), in any of FIGS. 8A to 8C, the receiver end user apparatus UE2 may perform channel estimation and demodulate the data signal by the DMRS with the same precoder as the precoder applied to the data signal.

In a case where the mapping illustrated in FIGS. 8A and 8B is performed, and the user apparatus UE2 is not enabled to identify, in advance, to which symbols the DMRSs, to which the same precoder is applied, are mapped, the user apparatus UE performs channel estimation as follows. For example, when the user apparatus UE searches (blind detection) the symbols #5, #8, and #11 using a DMRS sequence corresponding to the precoder 0 and detects the corresponding sequence, the user apparatus UE performs channel estimation using the DMRS of the symbol #2 and the DMRSs of the detected symbols. The user apparatus UE may perform channel estimation with the DMRSs corresponding to other precoders in the same manner as noted above.

For example, the mapping of a DMRS precoded by the precoder corresponding to a switch time interval may be predetermined for two symbols, i.e., one symbol in the switch time interval and the subsequent (or preceding) symbol, and such information may be preset in each user apparatus. In this case, the receiver end user apparatus UE2 may perform channel estimation using the DMRS sequence precoded by the precoder 0 in the first two symbols in one subframe without performing the above blind detection. The user apparatus UE2 may perform channel estimation with the DMRSs corresponding to other precoders in the same manner as noted above.

### Second Embodiment

The following describes a second embodiment. FIG. 9 is a diagram illustrating functional units (functional units included in a signal transmission unit 101 described later) related to precoding and signal transmission of the user apparatus UE1 in a second embodiment. As with the first embodiment, the functional units include a precoder 11 configured to precode a transmission signal (multiplying by precoding vector) and antenna ports 12 and 13.

The precoder 11 in the second embodiment holds a plurality of precoding vectors in a memory or the like, and switches each precoding vector according to time, in the same manner as the first embodiment. The plurality of precoding vectors are not particularly specified; however, the precoding vectors described in the codebook used for antenna ports {20, 21} are used as described in the first embodiment. This codebook is disclosed in Non-Patent Document 2. FIG. 7 depicts such a codebook.

The precoder 11 receives data signals and precodes the data signals to transmit the precoded signals from each antenna port as radio signals. In the second embodiment, a DMRS subject to precoding is not used, which differs from the first embodiment.

As illustrated in FIG. 9, in the second embodiment, an unprecoded RS (reference signal) similar to CRS of LTE is transmitted from each antenna port (each antenna element in the second embodiment) at a stage after the precoder 11. In the example of FIG. 9, S1 (first RS sequence) and S2 (second RS sequence) that are two RS sequences are alternately transmitted by each of the antenna port 12 (port 1) and the antenna port 13 (port 2). S1 and S2 transmitted in the same symbol are multiplexed and transmitted by CDM or FDM.

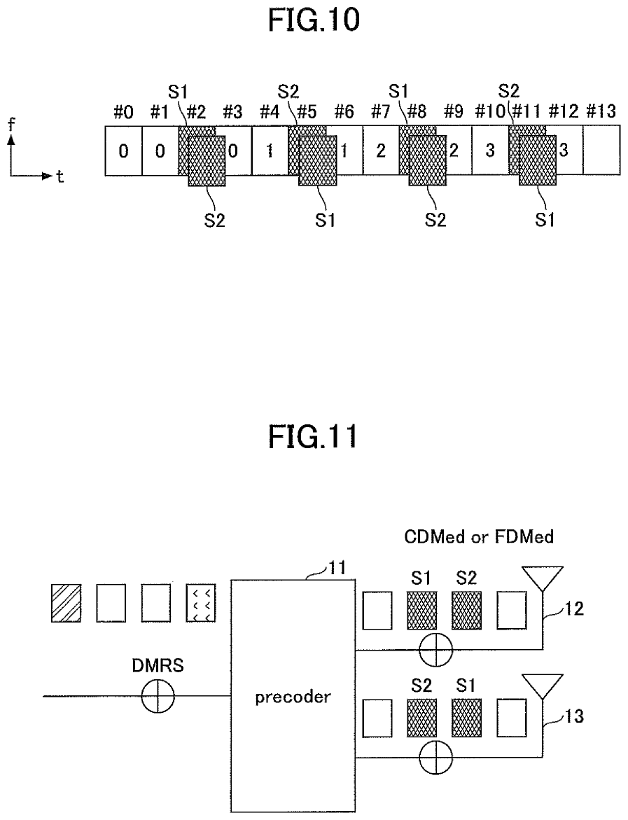

With reference to FIG. 10, examples of mapping data signals and RSs to resources (more specifically, resource elements) are described.

In FIG. 10, “0” written in the resource element indicates a symbol to which the data signal precoded by the precoder 0 is mapped, “1” indicates a symbol to which the data signal precoded by the precoder 1 is mapped, “2” indicates a symbol to which a data signal precoded by the precoder 2 is mapped, and “3” indicates a symbol to which the data signal precoded by the precoder 3 is mapped.

That is, the user apparatus UE 1 maps data signals precoded by the precoder 0 to the symbols #0, #1, and #3, maps data signals precoded by the precoder 1 to the symbols #4 and #6, maps data signals precoded by the precoder 2 to the symbols #7 and #9, and maps data signals precoded by the precoder 3 to the symbols #10 and #12. Such patterns of precoding (a pattern indicating which precode is applied in which switch time interval) are set from the base station 10 to the user apparatus UE1, for example. Further, such patterns may be defined by specifications or the like, the patterns may be held by the user apparatus UE1 in advance, the patterns may be transmitted by using a SCI (SA), and the patterns may each be uniquely determined from the CRC of the SA.

In addition, as illustrated in FIG. 10, the user apparatus UE1 maps S1 and S2 to symbols #2, #5, #8, and #11. Note that to map RS (S1 and S2) to each of symbols #2, #5, #8, and #11 is merely an example. RS may be mapped to more symbols than the example of FIG. 10 or RS may be mapped to fewer symbols (e.g., one symbol) than the example of FIG. 10. The pattern indicating the symbol to which the RS is mapped may also be set from the base station 10 to the user apparatus UE1 or the pattern defined in the specification or the like may be held by the user apparatus UE1 in advance.

In the second embodiment, it is assumed that the switch time position of the precoder, the precoder applied in each switch time interval, and the symbol to which the RS is mapped are known by each user apparatus, based on the setting from the base station 10, according to definitions of the specification, or the like.

There may be a case where the receiver end user apparatus UE2 is enabled to identify two RSs being mapped (multiplexed) to the symbols #2, #5, #8, and #11 and the multiplexing method (in FDM, the frequency position etc. of each RS), but is not enabled to identify the sequence of each RS. In such a case, for example, a plurality of pieces of information obtained from the content of SCI (SA) or its CRC may be associated with a plurality of first RS sequences (S1) in advance. Further, a cyclic shift offset (CS offset) for generating the second RS sequence from this sequence is also determined in advance. It is assumed that these pieces of information are known by each user apparatus.

The transmitter end user apparatus UE1 then transmits the SCI with respect to the data signal to be transmitted, maps a first RS sequence (S1) corresponding to the CRC of the SCI and a second RS sequence (S2) obtained from the first RS sequence (S1) by cyclic shift to the symbols #2, #5, #8, and #11, and transmits them together with the data signals.

The receiver end user apparatus UE2 receives the SCI and identifies the first RS sequence (S1) based on the content of the SCI or CRC of the SCI. Further, based on this sequence, the user apparatus UE2 identifies the second RS sequence (S2) by using CS offset, performs channel estimation using each RS, and demodulates the data signal. The user apparatus UE2 demodulates the data signal based on the precoder information (known) used in each switch time interval and the channel estimation result according to the two RSs.

In the second embodiment, two RS sequences of S1 and S2 are mapped to one symbol; however, this case is only an example. In the second embodiment, only one sequence may be mapped, or three or more sequences may be mapped.

### Third Embodiment

The following describes a third embodiment. The third embodiment is a combination of the first embodiment and the second embodiment.

FIG. 11 is a diagram illustrating functional units (functional units included in a signal transmission unit 101 described later) related to precoding and signal transmission of the user apparatus UE1 in the third embodiment. As with the first embodiment and the second embodiment, the functional units include a precoder 11 configured to precode a transmission signal (multiplying by precoding vector) and antenna ports 12 and 13.

The precoder 11 in the third embodiment holds a plurality of precoding vectors in a memory or the like, and switches each precoding vector according to time, in the same manner as the first embodiment and second embodiment. The plurality of precoding vectors are not particularly specified; however, the precoding vectors described in the codebook used for antenna ports {20, 21} are used as described in the first embodiment and the second embodiment. This codebook is disclosed in Non-Patent Document 2. FIG. 7 depicts such a codebook.

The precoder 11 receives data signals and DMRSs input as transmission signals, as in the first embodiment and the second embodiment. The precoder 11 precodes the data signal and DMRS to transmit the precoded signal and DMRS from each antenna port as radio signals.

As illustrated in FIG. 11, as in the second embodiment, unprecoded RS (reference signal) is transmitted from each antenna port (each antenna element in the present embodiment) at a stage after the precoder 11. In the example of FIG. 11, S1 (first RS sequence) and S2 (second RS sequence) that are two RS sequences are alternately transmitted by each of the antenna port 12 (port 1) and the antenna port 13 (port 2). S1 and S2 transmitted in the same symbol are multiplexed and transmitted by CDM or FDM.

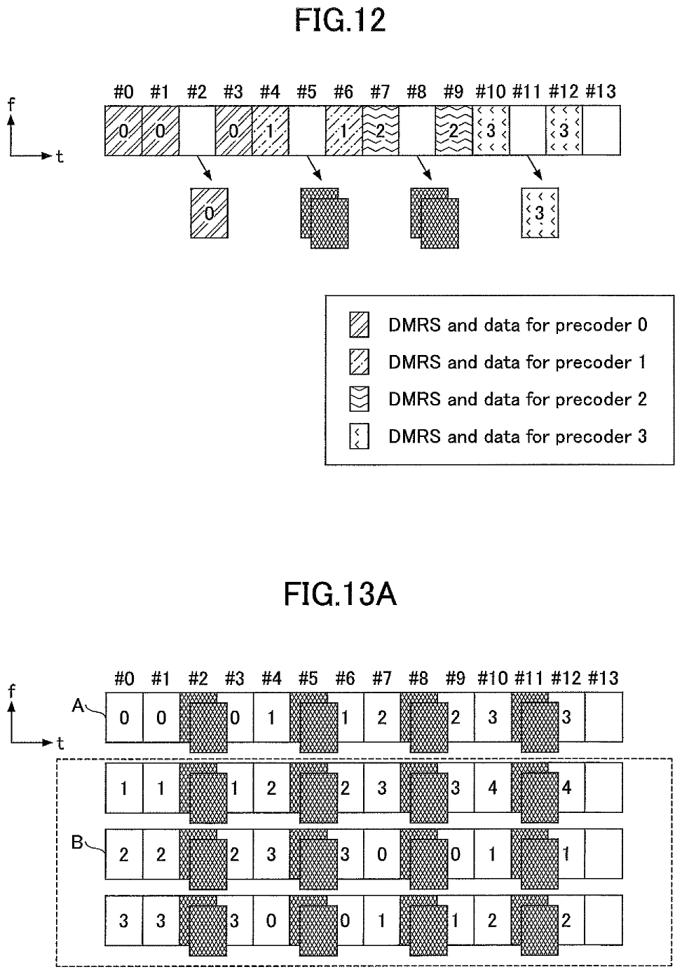

With reference to FIG. 12, examples of mapping DMRSs, data signals and unprecoded RSs to resources (more specifically, resource elements) are described.

In FIG. 12, “0” indicates a symbol to which the data signal precoded by the precoder 0 is mapped, “1” indicates a symbol to which the data signal precoded by the precoder 1 is mapped, “2” indicates a symbol to which a data signal precoded by the precoder 2 is mapped, and “3” indicates a symbol to which the data signal precoded by the precoder 3 is mapped.

Further, in the example of FIG. 12, DMRSs precoded by the precoder corresponding to the time position (switch time interval) are mapped respectively to symbol #2 (the symbol to which the first reference signal is mapped) and symbol #11 (the symbol to which the last reference signal is mapped). Further, the first RS sequence (S1) and the second RS sequence (S2) are each mapped to the symbol #5 and the symbol #8. Note that this mapping method is merely an example. DMRS (or RS) may be mapped to more symbols. As illustrated in FIGS. 8A and 8B of the first embodiment, the DMRS precoded by a certain precoder may be mapped to a plurality of symbols.

The user apparatus UE2, which receives the mapped signals illustrated in FIG. 12, may, for example, perform channel estimation using the DMRS of the symbol #2 and demodulate the data signals mapped to the symbols #0, #1, and #3. Further, the user apparatus UE2 performs channel estimation, for example, using the DMRS of the symbol #11 and demodulates the data signals mapped to the symbols #10 and #12. The user apparatus UE2 performs channel estimation using the first RS sequence (S1) and the second RS sequence (S2) by the method described in the second embodiment, and demodulates the data signals mapped to the symbols #4, #6, #7, and #9.

As described in the first and second embodiments, the user apparatus UE2 may determine sequences using the SCI CRC and the CS offset, and by using the determined sequences, estimate the sequences of the DMRS and RS.

In the first to fourth embodiments, SCI is used for reporting a pattern or a sequence. In such a case, any information on SCI, without being limited to CRS, may be used.

### Fourth Embodiment

The fourth embodiment is a modification from the second embodiment. The user apparatus UE 1 and the user apparatus UE2 in the fourth embodiment include the functions of the user apparatus UE1 and the user apparatus UE2 in the second embodiment. Hereinafter, the difference from the second embodiment (the features added from the second embodiment) will mainly be described. The processing features described below may be applied to the first embodiment or the third embodiment.

In the fourth embodiment, patterns of a plurality of precoding vectors used by the precoder 11 of the user apparatus UE1 are determined by specifications or the like, and the patterns are set in advance in each user apparatus. The base station 10 may set these patterns in the user apparatus UE1.

For example, when precoding vectors 0 to 3 (precoders 0 to 3) are used, a plurality of patterns (e.g., pattern 1={0, 1, 2, 3}, pattern 2={1, 0, 2, 3}, and pattern 3={3, 2, 1, 0}) are each defined as a pattern having the order of the application of the precoding vectors being changed, and are set in each user apparatus. Note that “0” indicates precoding vector 0. The other numbers similarly indicate precoding vectors accordingly. The order of numbers in each pattern indicates the order in which the corresponding precoding vector is applied. For example, the mapping illustrated in FIG. 10 corresponds to the mapping in a case of pattern 1 being applied.

Here, it is assumed that the information obtained from the contents of the SCI is associated with the pattern. The transmitter end user apparatus UE1 selects one pattern based on the contents (or CRC mask) of the SCI, performs the PVS applying the pattern, and transmits the data signal. For example, when pattern 1 is selected, the mapping signals illustrated in FIG. 10 are transmitted.

The receiver end user apparatus UE2 receives the SCI from the user apparatus UE1, determines the pattern used by the user apparatus UE1 based on the contents of the SCI, and demodulates the data signals based on the determined pattern. For example, when the pattern used by the user apparatus UE1 is the above pattern 1 (FIG. 10), the user apparatus UE2 determines that the precoding vectors applied to the symbols #0, #1, and #3 are “0” and uses the information of the precoding vector 0 to demodulate the data signal mapped to the symbols #0, #1, and #3.

Alternatively, one pattern may be defined, and the determined pattern may be set in advance in each user apparatus. In such a case, for example, the correspondence between information (numerical values, etc.) obtained from the contents (or CRC mask) of the SCI and the cyclic shift may be defined and set in advance for each user apparatus.

The user apparatus UE 1 that performs transmission by applying the above-mentioned one pattern selects one cyclic shift from a plurality of cyclic shifts defined in advance on the basis of the contents (or CRC mask) of the SCI, performs the PVS applying the cyclic shift pattern, and transmits the data signal.

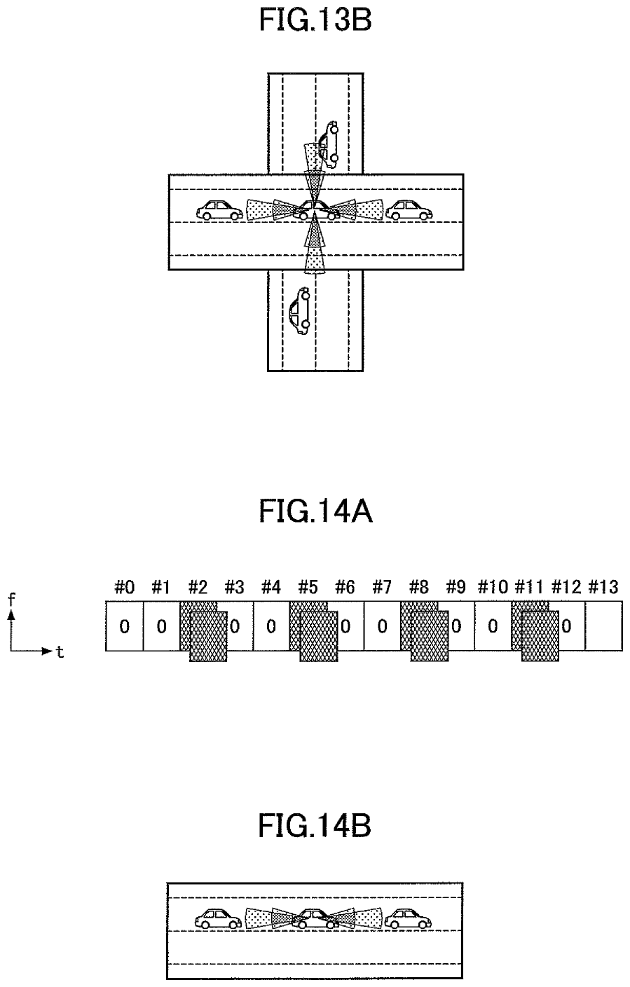

For example, in a case where the defined pattern is indicated by A in FIG. 13A and a cyclic shift indicating “shift by two precoding vectors to the left” is selected as the cyclic shift, the pattern indicated by B is applied. The application of such a cyclic shift enables randomization of interference between user apparatuses. As an example, FIG. 13B illustrates an image of V2V (vehicle-to-vehicle communication). In a case where a pattern is a fixed one, the vehicle in the middle illustrated in FIG. 13B may intensively receive interference. By contrast, as illustrated in the fourth embodiment, the pattern may be dispersed by the cyclic shift, which randomizes interference to thereby reduce the interference.

Further, in a case of defining a plurality of patterns, the user apparatus UE1 may include the index of the pattern in the SCI and transmit the SCI including this index. In this case, the receiver end user apparatus UE2 receives the SCI from the user apparatus UE1, determines the pattern used by the user apparatus UE1 based on the index included in the SCI, and demodulates the data signal based on the determined pattern. Note that the user apparatus UE1 may select any pattern. For example, the user apparatus UE1 may select a pattern for “transmit diversity” or may select a pattern for beam forming.

FIG. 14A illustrates an example of a pattern for beam forming. In this case, only one precoding vector is used; when there is no change in the direction of the user apparatus UE1, the user apparatus UE1 constantly transmits the transmission beam in the same direction. In 3GPP, a use case in platooning (e.g., a plurality of vehicles running in a row) as illustrated in FIG. 14B is being studied as Phase 2 of V2X. The pattern as illustrated in FIG. 14A may be preferable in such a case.

### Others

In each of the first to fourth embodiments, the user apparatus UE1 may report to the user apparatus UE2 with the SCI (PSCCH) whether to apply transmit diversity to the data signal (PSSCH). For example, the user apparatus UE2 that has received the information indicating “presence” of transmit diversity may determine to perform the search operation (blind detection) of the DMRS described in the first embodiment (as required).

The user apparatus UE1 may report to the user apparatus UE2 with the SCI (PSCCH) index of DMRS/RS mapping pattern, mapping contents (such as which RS has been mapped to which symbol) to the symbols of DMRS/RS (especially precoded DMRS), and/or the index of the applied precoder cycling pattern (specifically, in the case of an RS not being precoded).

Each information to be reported is, for example, preconfigured information or information set from an upper layer (e.g., configuration by RRC signaling from the base station 10), or the like.

### Device Configurations

The following illustrates a functional configuration example of the user apparatus UE and the base station 10 that execute the processing operations described so far. The user apparatus UE and the base station 10 may have all the functions of the first embodiment, the second embodiment, the third embodiment, the fourth embodiment, etc., may have functions of only one of the five embodiments, or may have functions of four, three or two of the five embodiments.

### User Apparatus

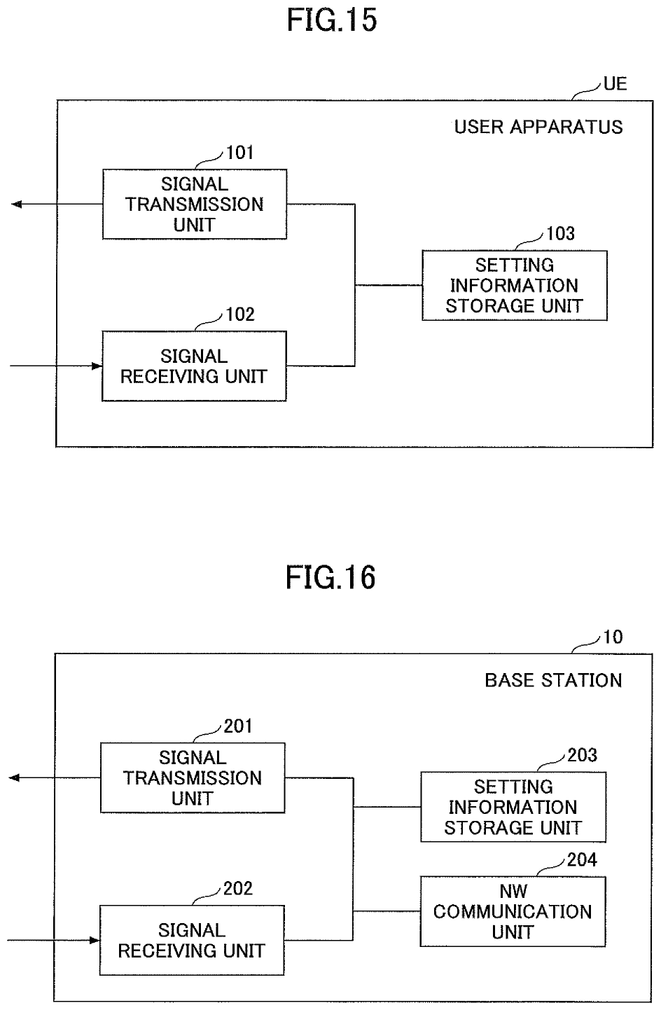

FIG. 15 is a diagram illustrating another functional configuration example of a user apparatus. As illustrated in FIG. 15, the user apparatus UE includes a signal transmission unit 101, a signal receiving unit 102, and a setting information storage unit 103. The functional configuration of the user apparatus UE illustrated in FIG. 15 is merely an example. Any functional division and any terms for describing the functional components may be applied insofar as the operations according to the present embodiment may be executed.

The signal transmission unit 101 configured to create a transmission signal from the transmission data and wirelessly transmit the transmission signal. The signal receiving unit 102 configured to wirelessly receive various signals and acquire signals of a higher layer from the received signals of the physical layer. Each of the signal transmission unit 101 and the signal receiving unit 102 includes a D2D function and a cellular communication function. The signal transmission unit 101 includes a function of executing the signal transmission operations described in the first to fourth embodiments and others, and the signal receiving unit 102 includes a function of executing the signal receiving operations described in the first to fourth embodiments and others.

The setting information storage unit 103 is configured to store various configuration information received from the base station 10 via the signal receiving unit 102 and store configuration information in advance. For example, the setting information storage unit 103 is configured to store a plurality of precoding matrices.

The signal transmission unit 101 is configured to precode a D2D signal and transmit the precoded D2D signal while switching a precoding matrix among the plurality of precoding matrices in a time domain, in a predetermined time interval including a plurality of unit time intervals. For example, the signal transmission unit 101 maps reference signals precoded with the same precoding matrix to at least two unit time intervals in the predetermined time interval.

Further, the signal transmission unit 101 may also map reference signals that are not precoded in at least one unit time interval in the predetermined time interval. Further, the setting information storage unit 103 stores a plurality of types of patterns indicating a time sequence, in which a plurality of precoding matrices are to be applied, and in a case of precoding the D2D signal according to a specific pattern among the plurality of types of patterns, the signal transmission unit 101 may transmit control information including information corresponding to the specific pattern. The signal transmission unit 101 may cyclically shift a pattern indicating a time sequence, in which a plurality of precoding matrices are to be applied, to precode the D2D signal while switching a plurality of patterns. The signal transmission unit 101 may transmit control information including information corresponding to the cyclic shift used for the precoding of the D2D signal.

### Base Station 10

FIG. 16 is a diagram illustrating a functional configuration example of a base station 10. As illustrated in FIG. 16, the base station 10 includes a signal transmission unit 201, a signal receiving unit 202, a setting information storage unit 203, and a NW communication unit 204. The functional configuration of the base station 10 illustrated in FIG. 16 is merely an example. Any functional division and any terms for describing the functional components may be applied insofar as the operations according to the present embodiment may be executed.

The signal transmission unit 201 includes a function of generating a signal to be transmitted to the user apparatus UE and transmitting the signal wirelessly. The signal receiving unit 202 includes a function of receiving various signals transmitted from the user apparatus UE and acquiring, for example, information of a higher layer from the received signal.

The signal transmission unit 201 includes a function of executing the operation of transmitting a signal (e.g., setting information) to the user apparatus UE as described in the first to fourth embodiments and others.

The setting information storage unit 203 stores various setting information to be transmitted to the user apparatus UE, various types of setting information received from the user apparatus UE, and preset setting information. The NW communication unit 204 is configured to execute information communication between base stations, for example.

### Hardware Configuration

The block diagrams (FIGS. 15 and 16) used in the description of the above embodiment indicates blocks of functional units. These functional blocks (functional components) are implemented by any combination of hardware components or software components. The components for implementing respective functional blocks are not particularly specified. That is, the functional blocks may be implemented by one device physically and/or logically combining multiple elements or may be implemented by two or more physically and/or logically separated devices that are connected directly and/or indirectly (e.g., wired and/or wireless).

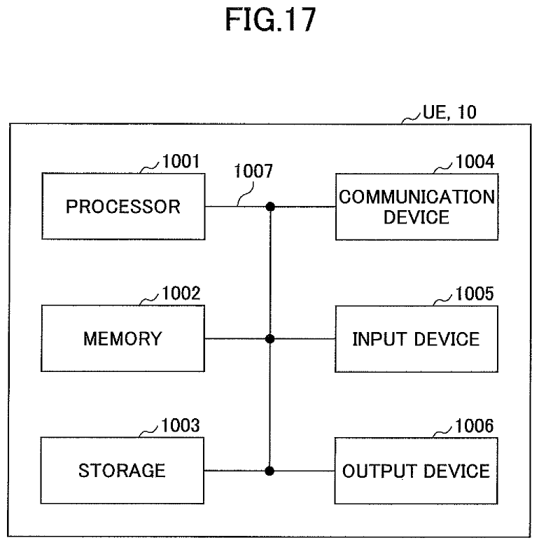

Further, each of the user apparatus UE and the base station 10 in one embodiment of the present invention may function as a computer that performs the process according to this embodiment. FIG. 17 is a diagram illustrating an example of a hardware configuration of the user apparatus UE and the base station 10 in an embodiment of the present invention. Each of the user apparatus UE and the base station 10 described above may be physically configured as a computer device including a processor 1001, a memory 1002, a storage 1003, a communication device 1004, an input device 1005, an output device 1006, and a bus 1007.

In the following description, the term “device” may be replaced with a circuit, an apparatus, a unit, or the like. The hardware configuration of the user apparatus UE or the base station 10 may be configured to include one or more of the respective devices illustrated with reference to 1001 to 1006 in FIG. 17 or may be configured without including some of the devices.

The functions of the user apparatus UE or the base station 10 are implemented by allowing predetermined software (programs) to be loaded on the hardware such as the processor 1001, the memory 1002, and the like, so as to cause the processor 1001 to perform calculations to control communications by the communication device 1004, and reading and/or writing of data in the storage 1003.

The processor 1001 may, for example, operate an operating system to control the entire computer. The processor 1001 may be configured to include a central processing unit (CPU) having an interface with peripherals, a control device, an operation device, and registers.

In addition, the processor 1001 loads programs (program codes), software modules or data from the storage 1003 and/or the communication device 1004 into the memory 1002, and executes various processes according to the loaded programs, software modules or data. The programs are configured to cause a computer to execute at least a part of the operations described in the above embodiment. For example, the signal transmission unit 101, the signal receiving unit 102, and the setting information storage unit 103 of the user apparatus UE illustrated in FIG. 15 may be implemented by a control program that is stored in the memory 1002 and that operates on the processor 1001. For example, the signal transmission unit 201, the signal receiving unit 202, the setting information storage unit 203, and the NW communication unit 204 of the base station 10 illustrated in FIG. 16 may be implemented by a control program that is stored in the memory 1002 and that operates on the processor 1001. The above-described various processes described as being executed by one processor 1001; however, these processes may be executed simultaneously or sequentially by two or more processors 1001. The processor 1001 may be implemented by one or more chips. Note that the programs may be transmitted from the network via an electric communication line.

The memory 1002 may be a computer-readable recording medium composed of at least one of a ROM (Read Only Memory), an EPROM (Erasable Programmable ROM), an EEPROM (Electrically Erasable Programmable ROM), a RAM (Random Access Memory) and the like. The memory 1002 may be referred to as a register, a cache, a main memory (a main storage device), or the like. The memory 1002 may store executable programs (program codes), software modules, and the like for implementing a process according to the embodiment of the present invention.

The storage 1003 is a computer-readable recording medium composed, for example, of at least one of an optical disk such as a CD-ROM (Compact Disk ROM), a hard disk drive, a flexible disk, a magneto-optical disk (e.g., a compact disk, a digital versatile disk, and a Blu-ray (registered trademark) disk), a smart card, a flash memory (e.g., a card, a stick, and a key drive), a floppy (registered trademark) disk, and a magnetic strip. The storage 1003 may be referred to as an auxiliary storage device. The above-described storage medium may be, for example, a database, a server, or another appropriate medium including the memory 1002 and/or the storage 1003.

The communication device 1004 is hardware (a transmitting-receiving device) for performing communications between computers via a wired and/or wireless network. The communication device 1004 may also be referred to as a network device, a network controller, a network card, a communication module, or the like. For example, the signal transmission unit 101 and the signal receiving unit 102 of the user apparatus UE may be implemented by the communication device 1004. Further, the signal transmission unit 201, the signal receiving unit 202, and the NW communication unit 204 of the base station 10 may be implemented by the communication device 1004.

The input device 1005 is configured to receive an input from the outside. Examples of the input device include a keyboard, a mouse, a microphone, a switch, a button, and a sensor. The output device 1006 is configured to generate an output to the outside. Examples of the output device include a display, a speaker, and an LED lamp. Note that the input device 1005 and the output device 1006 may be integrated (e.g., a touch panel).

In addition, the respective devices such as the processor 1001 and the memory 1002 may be connected by a bus 1007 for mutually communicating information with one another. The bus 1007 may be composed of a single bus or may be composed of different buses between the devices.

Further, the user apparatus UE or the base station 10 may include hardware such as a microprocessor, a digital signal processor (DSP), an ASIC (Application Specific Integrated Circuit), a PLD (Programmable Logic Device), and an FPGA (Field Programmable Gate Array). Alternatively, a part or all of the functional blocks of the user apparatus UE or the base station eNB may be implemented by those hardware components. For example, the processor 1001 may be implemented with at least one of these hardware components.

### Summary of Embodiments

As described above, an aspect of an embodiment may provide a user apparatus for use in a radio communication system that supports D2D communication. The user apparatus includes a setting information storage unit configured to store a plurality of precoding matrices; and a signal transmission unit configured to precode a D2D signal and transmit the precoded D2D signal while switching a precoding matrix among the plurality of precoding matrices in a time domain, in a predetermined time interval including a plurality of unit time intervals, where the signal transmission unit maps a reference signal precoded by the same precoding matrix to at least two unit time intervals in the predetermined time interval.

According to the above-described configuration, a user apparatus is enabled to apply a precoding vector switch to appropriately perform D2D communication, in a radio communication system supporting D2D communication. Specifically, according to the above-described configuration, the reference signal precoded by the same precoding matrix is mapped to at least two unit time intervals, which enables the receiver side to appropriately perform channel estimation.

Further, an aspect of an embodiment may provide a user apparatus for use in a radio communication system that supports D2D communication. The user apparatus includes a setting information storage unit configured to store a plurality of precoding matrices; and a signal transmission unit configured to precode a D2D signal and transmit the precoded D2D signal while switching a precoding matrix among the plurality of precoding matrices in a time domain, in a predetermined time interval including a plurality of unit time intervals, where the signal transmission unit maps an unprecoded reference signal to at least one unit time interval in the predetermined time interval.

In addition, an aspect of an embodiment may provide a technology that enables a user apparatus to apply a precoding vector switch to appropriately perform D2D communication, in a radio communication system supporting D2D communication. According to the above-described configuration, the user apparatus maps unprecoded reference signals, which enables the user apparatus to achieve relatively compact implementation.

The setting information storage unit stores a plurality of types of patterns indicating a time sequence, in which a plurality of precoding matrices are to be applied, and in a case of precoding the D2D signal according to a specific pattern among the plurality of types of patterns, the signal transmission unit transmits control information including information corresponding to the specific pattern. According to the above-described configuration, the user apparatus is enabled to change a pattern as needed to flexibly manage interference according to an interference situation.

The signal transmission unit may cyclically shift a pattern indicating a time sequence, in which a plurality of precoding matrices are to be applied, to precode the D2D signal while switching a plurality of patterns. According to the above-described configuration, the user apparatus is enabled to change a pattern by cyclically shifting the pattern to flexibly manage interference according to an interference situation.

The signal transmission unit may transmit control information including information corresponding to the cyclic shift used for the precoding of the D2D signal. According to this configuration, the receiver side is enabled to easily identify the pattern used by the transmitter side.

### Supplementary Description of Embodiments

The embodiments have been described as described above; however, the disclosed invention is not limited to these embodiments, and a person skilled in the art would understand various variations, modifications, replacements, or the like. Specific examples of numerical values have been used for encouraging understanding of the present invention; however, these numeric values are merely examples and, unless otherwise noted, any appropriate values may be used. In the above description, partitioning of items is not essential to the present invention. Matters described in more than two items may be combined if necessary. Matters described in one item may be applied to matters described in another item (as long as they do not conflict). In a functional block diagram, boundaries of functional units or processing units do not necessarily correspond to physical boundaries of parts. Operations of multiple functional units may be physically performed in a single part, or operations of a single functional unit may be physically performed by multiple parts. The order of steps in the above described operating procedures according to an embodiment may be changed as long as there is no contradiction. For the sake of convenience, the user apparatus UE and the base station 10 have been described by using functional block diagrams. These apparatuses may be implemented by hardware, by software, or by combination of both. The software which is executed by a processor included in the user apparatus UE according to an embodiment and the software which is executed by a processor included in the base station 10 may be stored in a random access memory (RAM), a flash memory, a read-only memory (ROM), an EPROM, an EEPROM, a register, a hard disk drive (HDD), a removable disk, a CD-ROM, a database, a server, or any other appropriate recording medium.

Further, reporting of information is not limited to the aspects/embodiments described in this specification, and may be performed in other ways. For example, reporting of information may be performed by physical layer signaling (e.g., DCI (Downlink Control Information), UCI (Uplink Control Information)), upper layer signaling (e.g., RRC (Radio Resource Control) signaling, MAC (Medium Access Control) signaling, broadcast information (MIB (Master Information Block) and SIB (System Information Block)), and other signals or a combination thereof. Further, RRC signaling may be referred to as an RRC message, and may be an RRC connection setup (RRCC connection setup) message, an RRC connection reconfiguration (RRCC connection reconfiguration) message, or the like.

Each aspect/embodiment described herein may be applied to LTE (Long Term Evolution), LTE-A (LTE-Advanced), SUPER 3G, IMT-Advanced, 4G, 5G, FRA (Future Radio Access), W-CDMA (registered trademark), GSM (registered trademark), CDMA 2000, UMB (Ultra Mobile Broadband), IEEE 802.11 (Wi-Fi), IEEE 802.16 (WiMAX), IEEE 802.20, UWB (Ultra-Wide Band), Bluetooth (registered trademark), and a system that utilize other suitable systems and/or a next generation system expanded based on such a system.

The order of processes, sequences, flowcharts, etc. of each aspect/embodiment described in the present specification may be exchanged as long as there is no inconsistency. For example, for the methods described herein, elements of the various steps are presented in an exemplary order and are not limited to the specific order presented.

The specific operation that is performed by the base station 10 in this specification may be performed by its upper node in some cases. In a network composed of one or more network nodes having a base station 10, it is clear that the various operations performed for communication with the user apparatus UE may be performed by other network nodes than the base station 10 and/or the base station 10. Examples of such other network nodes include, but not limited to, MME or S-GW. In the above embodiments, a case where there is one network node other than the base station 10 is described; however, a plurality of other network nodes other than the base station 10 may be combined (e.g., MME and S-GW).

Aspects/embodiments described in this specification may be used alone or in combination, or may be switched in accordance with execution.

The user apparatus UE may also be referred to, by those skilled in the art, as a subscriber station, a mobile unit, a subscriber unit, a wireless unit, a remote unit, a mobile device, a wireless device, a wireless communication device, a remote device, a mobile subscriber station, a access terminal, a mobile computer, a wireless terminal, a remote terminal, a mobile subscriber station, a access terminal, a mobile computer, a wireless terminal, a remote terminal, a handset, a user agent, a mobile client, a client, or several other suitable terms.

The base station 10 may also be referred to, by those skilled in the art, as NB (Node B), eNB (enhanced Node B), Base Station, gNB, or several other suitable terms.

As used herein, the terms “determining” and “deciding” may encompass a wide variety of actions. The terms “determining” and “deciding” may be deemed to include, for example, judging, calculating, computing, processing, deriving, investigating, looking up (e.g., searching tables, databases or other data structures), and ascertaining. Further, the terms “determining” and “deciding” may be deemed to include, for example, receiving (e.g., receiving information), transmitting (e.g., transmitting information), input, output, and accessing (e.g., accessing data in memory). Moreover, the terms “determining” and “deciding”, may be deemed to include, for example, resolving, selecting, choosing, establishing, and comparing (comparing). In other words, the terms “determining” and “deciding” may be deemed to include, “determining” and “deciding” to take some action.

As used herein, the phrase “based on” does not mean “based only on” unless explicitly stated otherwise. In other words, the phrase “based on” means both “based only on” and “based at least on”.

As long as “include”, “including”, and variations thereof are used in the specification or claims, these terms are intended to be inclusive in a manner similar to the term “comprising”. Furthermore, the term “or” used in the specification or claims is intended to be not an exclusive “or”.

In the entirety of the present disclosure, articles, such as a, an, or the in English that are added to a noun term by translation may indicate a plurality of the noun terms unless the articles obviously indicate a singular noun from the context.

The present invention has been described in detail above; it will be obvious to those skilled in the art that the present invention is not limited to the embodiments described herein. The present invention may be implemented as revised and modified embodiments without departing from the spirit and scope of the present invention as defined by the scope of the claims. Therefore, the present specification is described for the purpose of illustrating examples and does not have any restrictive meaning to the present invention.

### DESCRIPTION OF REFERENCE SIGNS

UE user apparatus
101 signal transmission unit
102 signal receiving unit
103 setting information storage unit
10 base station
201 signal transmission unit
202 signal receiving unit
203 setting information storage unit
204 NW communication unit
1001 processor
1002 memory
1003 storage
1004 communication device
1005 input device
1006 output device

1. A user apparatus for use in a radio communication system, the radio communication system supporting a D2D communication, the user apparatus comprising:
a setting information storage unit configured to store a plurality of precoding matrices; and
a signal transmission unit configured to precode a D2D signal and transmit the precoded D2D signal while switching a precoding matrix among the plurality of precoding matrices in a time domain, in a predetermined time interval including a plurality of unit time intervals, wherein
the signal transmission unit maps a reference signal precoded by a same precoding matrix to at least two unit time intervals in the predetermined time interval.

2. A user apparatus for use in a radio communication system, the radio communication system supporting a D2D communication, the user apparatus comprising:
a setting information storage unit configured to store a plurality of precoding matrices; and
a signal transmission unit configured to precode a D2D signal and transmit the precoded D2D signal while switching a precoding matrix among the plurality of precoding matrices in a time domain, in a predetermined time interval including a plurality of unit time intervals, wherein
the signal transmission unit maps an unprecoded reference signal to at least one unit time interval in the predetermined time interval.

3. The user apparatus according to claim 1, wherein
the setting information storage unit stores a plurality of types of patterns each indicating a time sequence in which a plurality of precoding matrices are to be applied, and
upon precoding the D2D signal according to a specific pattern among the plurality of types of patterns, the signal transmission unit transmits control information including information corresponding to the specific pattern.

4. The user apparatus according to claim 1, wherein
the signal transmission unit cyclically shifts a pattern indicating a time sequence, in which a plurality of precoding matrices are to be applied, to precode the D2D signal while switching a plurality of patterns.

5. The user apparatus according to claim 4, wherein
the signal transmission unit transmits control information including information corresponding to the cyclic shift used for the precoding of the D2D signal.

6. A communication method for use in a radio communication system supporting D2D communication and executed by a user apparatus, the user apparatus having a setting information storage unit configured to store a plurality of precoding matrices, the communication method comprising:
precoding a D2D signal and transmitting the precoded D2D signal while switching a precoding matrix among the plurality of precoding matrices in a time domain, in a predetermined time interval including a plurality of unit time intervals, wherein
the precoding step includes mapping a reference signal precoded by a same precoding matrix to at least two unit time intervals in the predetermined time interval.

7. The user apparatus according to claim 2, wherein
the setting information storage unit stores a plurality of types of patterns each indicating a time sequence in which a plurality of precoding matrices are to be applied, and
upon precoding the D2D signal according to a specific pattern among the plurality of types of patterns, the signal transmission unit transmits control information including information corresponding to the specific pattern.

8. The user apparatus according to claim 2, wherein
the signal transmission unit cyclically shifts a pattern indicating a time sequence, in which a plurality of precoding matrices are to be applied, to precode the D2D signal while switching a plurality of patterns.
